(19) United States
(12) Patent Application Publication
(10) Pub. No.: US 2003/0101629 A1
(43) Pub. Date: Jun. 5, 2003

(54) Customized advertising display and method of making the same

(76) Inventors: Peter Shaw Lingamfelter, New Braunfels, TX (US); Neisha Bell Lingamfelter, New Braunfels, TX (US); C. Brown Lingamfelter, Boxborough, MA (US)

Correspondence Address: Daniel D. Chapman, Jackson Walker L.L.P., Suite 2100, 112 E. Pecan, San Antonio, TX, 78205, US

(21) Appl. No.: 10/254,991

(22) Filed: Sep. 25, 2002

Related U.S. Application Data
(62) Division of application No. 09/366,983, filed on Aug. 4, 1999, now abandoned.

(51) Int. Cl. G09F 3/10

(52) U.S. Cl. 40/638

(57) ABSTRACT

Applicant's unique method provides for the use of a single piece of transfer tape for multiple transfers, with the transfer tape being forgiving, clear, having a high shelf life, and being non-self destructive. Such a method has been heretofore unavailable.

### FIELD OF THE INVENTION

Sign making, more specifically, utilizing a unique method of transferring vinyl sign designs from backing paper to a substrate. Advertising displays. More specifically, a base-mountable customized advertising membrane and a method for making the same.

### BACKGROUND OF THE INVENTION

In the last 15 years or so, the use of vinyl for sign making, especially for designating letters or numbers, has become common. Sheets of vinyl, which are adhered to a protective (typically paper) backing host utilizing an adhesive, are cut into the desired shape and then transferred from their protective backing to a suitable substrate. These vinyl letters and/or numbers or other designs are frequently used on automobiles, planes, billboards, windows, sign substrates, and the like. The letters and/or numbers and/or devices come in various sizes and colors.

Sign makers transfer the vinyl letters from the paper backing to the substrate through the use of transfer tape. Several companies that provide distribute tape are: Spartan International, Inc., 1845 Cedar Holt, Mich. 48842; R Tape Corp., #6 Ingersol Road, South Plainfield, N.J. 07080; and Vector TM Graphics, 925 Sawmill River Road, Yonkers, N.Y. 10710. The transfer tape comes in a roll and is usually opaque, sometimes non-opaque. The transfer tape is sticky on one side and is flexible. The sign maker removes the transfer tape from its roll and cuts it to a size sufficient to transfer the vinyl letters from their backing to the substrate. The transfer tape is pressed against the precut vinyl design and the pressure-sensitive adhesive picks up the vinyl off its backing. The vinyl designs are then ready to place against the substrate. Pressure against the transfer paper and vinyl applied evenly helps ensure good adhesion of the design to the substrate. Following the transfer, the transfer tape is pulled off the designs and then discarded.

Heretofore, the transfer tape has not been capable of multiple transfers in duplicating the process of transferring the designs from the backing to the substrate. That is, heretofore, transfer tape has been “single use”. Moreover, transfer tape has, heretofore, been self destructive. By self destructive it is meant that, if one portion of the adhesion side of the transfer tape is to touch another portion of the same side of the transfer tape, subsequent separation typically removes the adhesive layer from one of the two touching portions or destroys its adhesive ability.

Clearly, utility lies in the discovery of a medium to use in place of the heretofore available transfer tape which will allow multiple uses of the same piece of transfer tape for a multiplicity of transfers. Moreover, it is clear that utility will lie in the use of a transfer tape that is non-self destructive—meaning that, if one adhesive portion of the transfer tape touches another, subsequent separation will not destroy the tackiness and ability of the tape to subsequently transfer vinyl from a protective host backing to a substrate. Utility also lies in the utilization of a clear transfer tape so as to allow better positioning of the design to the substrate, especially where registration marks or the like are applied to the substrate to assist in positioning. Last, utility lies in the use of a transfer tape that, between transfers, can be placed sticky side down onto a temporary backing medium to protect its adhesive side when not in use, but which may be released and reused for transfers without destroying its tackiness.

Thus, utility is provided in transfer tape that provides sufficient tack (adhesive) capabilities (including tack retention) such that it can be used repeatedly to transfer vinyl letters from a paper backing to a substrate. Further utility lies in a transfer tape sufficiently clear to allow proper positioning of the vinyl letter material to the substrate. Further utility lies in the use of a transfer tape that can be placed against foreign surfaces but which will release and allow re-adhesion to vinyl sign material capable to lift such material off its backing. Further utility lies in the use of a transfer tape that has a high shelf life, specifically one which, after one or more uses, may be set aside for a period of approximately 30 days and then reused to transfer vinyl sign material from a paper backing to a substrate.

### SUMMARY OF THE INVENTION

In summary, applicant's unique method provides for the use of a single piece of transfer tape for multiple transfers, with the transfer tape being forgiving, clear, having a high shelf life, and being non-self destructive. Such a method has been heretofore unavailable. Signage, such as billboards, window signs, and a point-of-sale display signs, are an important medium through which advertisers display messages bearing information regarding their goods or services. Traditionally, signs have been manufactured in a number of ways. One of the oldest methods is simply free-hand painting onto a display base or member. Signs also made from computer-cutting of self-adhesive vinyl designs, letters, or numbers, which are then transferred to an appropriate backing or base member for display.

In fact, the use of computer operated vinyl cutters has greatly enhanced the ability of the sign maker to customize messages. The sign maker can scan in a design, or type in a message, and the computer will provide graphics allowing the combination of designs, letters, numbers, etc. When the desired effect is achieved, the computer will cut the necessary designs, pictures, numbers, or letters according to the selected display.

Ink jet printers (such as those available form Signtech), 4669 Highway 90 West, San Antonio, Tex. 78237 under the trademark SALSA), or the VUTEk 5300/3300 (available from VUTEk, Inc., 189 Waukewan Street, Meredith, N.H. 03253) can print onto flexible vinyl members, ink through computer-controlled ink jet spray heads. An image may be scanned into a computer which controls the ink passing through a jet to control the color applied to a substrate, to closely match that of the scanned image.

Such digitally controlled ink jet printers (such as those set forth above) are available in extra wide format, up to 17 feet. They have the ability to print on may different types of material, including vinyl, cloth, self-adhesive sheet, paper, and mesh. Such customized printing may then be used for trade show displays, kiosks, marquee, point-of-sale, banners, billboards, on-premise signage, and many other speciality markets.

When self-adhesive sheets have been used in the past, they have not been removable and repositionable. That is, Applicant's self-adhesive vinyl sheet is used where the adhesive properties allow the sheet to then be removed and repositioned without losing any adhesive material from the flexible vinyl sheet substrate. Applicant's sheet leaves little or no adhesive on the mounting base.

### BRIEF DESCRIPTION OF THE DRAWINGS

FIGS. 1-5 illustrate, in perspective views, the steps, set forth sequentially, of applicant's method.

FIGS. 6A and 6B illustrate perspective views of the unique, flexible, vinyl plastic, self-adhesive sheet used in Applicant's unique method.

FIG. 7 is a perspective view of a typical digital printing system for use with Applicant's unique method and device.

FIGS. 8A and 8B are perspective views of a sign made with Applicant's unique method and device.

FIG. 9 illustrates the use of several sections of Applicant's vinyl sheet placed adjacent one another on a base, which base is in turn mounted to a receptacle such as a billboard frame.

### DETAILED DESCRIPTION OF THE PREFERRED EMBODIMENT

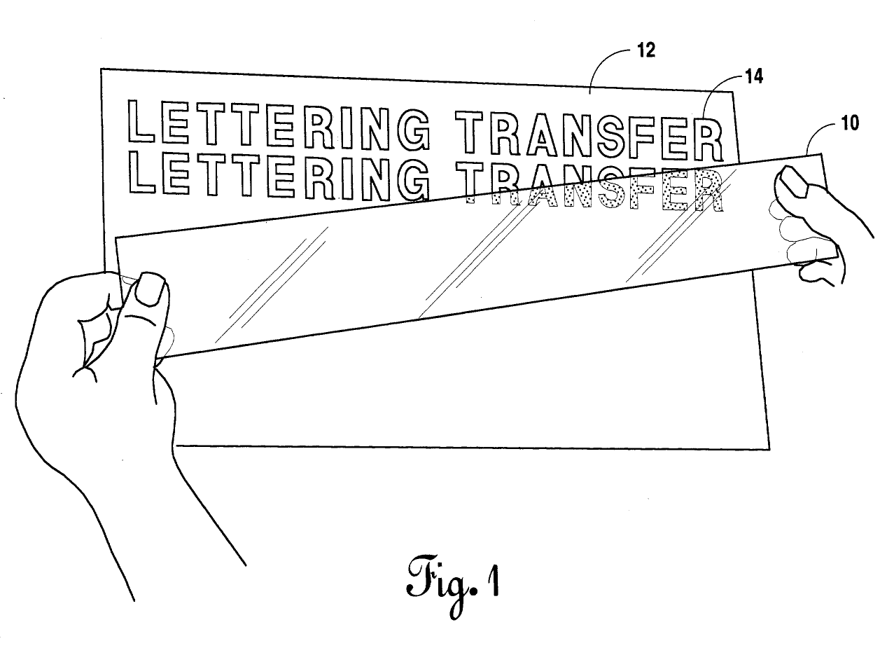

FIGS. 1-5 illustrate a typical transfer operation whose objective is to transfer vinyl designs (such as letters) from an adhesive backing to a substrate.

Here, in FIG. 1, the user is illustrated holding a piece of appropriately sized transfer tape (10) stretched between his hands and poised to place it, adhesive side down, to vinyl sign material (12) with letters (14) cut out.

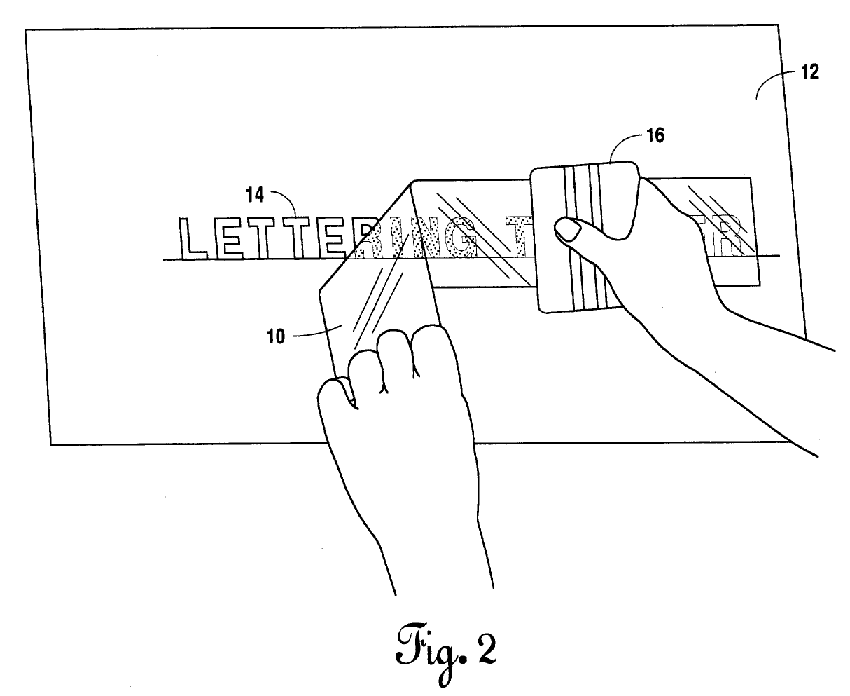

FIG. 2 illustrates the application of transfer tape (10) to letters (14) by applying pressure, as through a squeegee (16).

FIG. 3 illustrates the user holding vinyl sign material (12) down as transfer tape (10) is lifted off, the lift off releasing letters (14) from the paper backing of vinyl sign material (12) and onto the adhesive side of transfer tape (10).

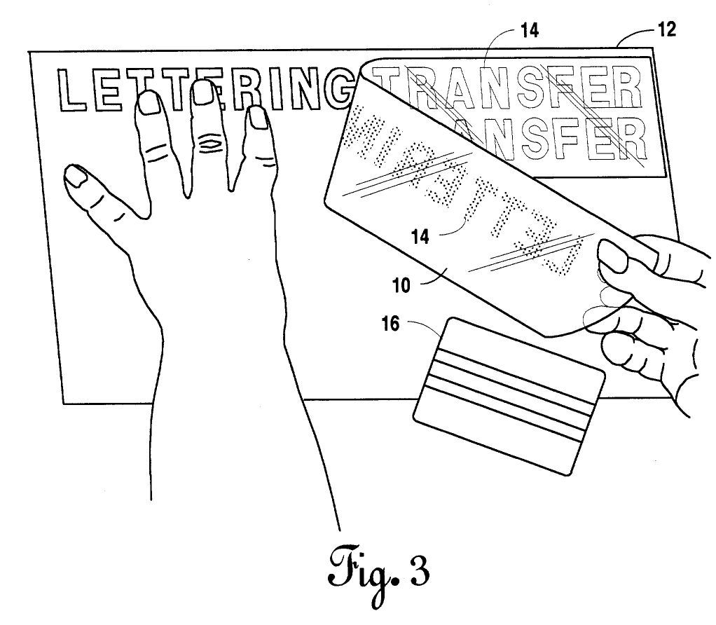

FIG. 4 illustrates transfer tape (10) with all of vinyl letters (14) attached to the adhesive side thereof, having been lifted off from their paper backing, with the user poised to place the letters on substrate (18) in their preferred location.

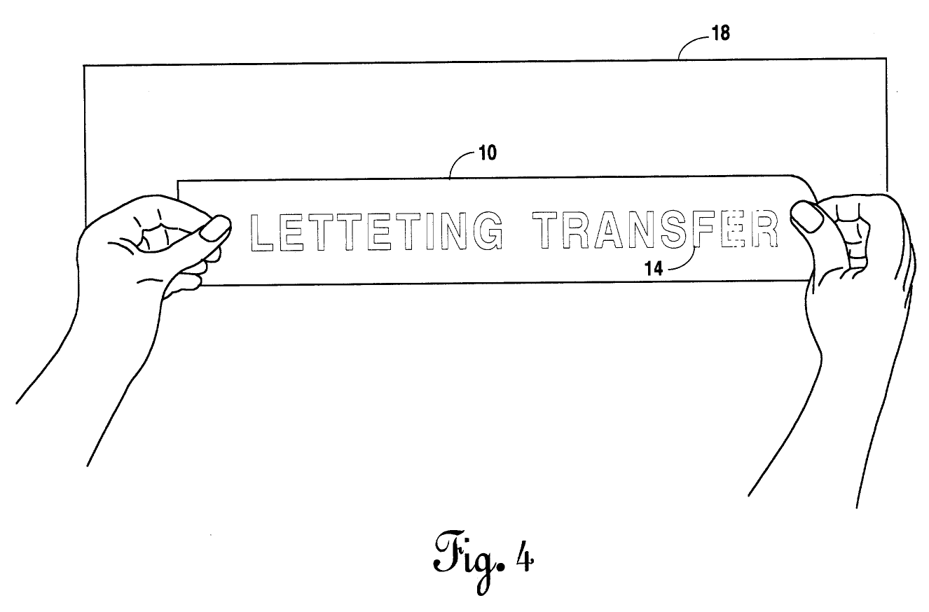

FIG. 5 illustrates the removal of transfer tape (10) from letters (14), letters (14) having been adhered to by the application of pressure, as through a squeegee (16) (see FIG. 2), being rubbed across the non-adhesive side of transfer tape (10) to force the letters (14) onto substrate (18). The removal of the transfer tape leaves letters (14) on the substrate (18). The removal is effected by a slow uniform pull of one end of the transfer tape (10) across the substrate, generally along the longitudinal axis of the transfer tape.

Applicant's method then, is for the repetition of the above steps using the same piece of transfer tape for transferring vinyl signage designs which have an adhesive and non-adhesive side, the adhesive side adhering to a protective backing or host paper to a substrate, typically glass, metal, fiberglass, wood, stiff plastic, styrene, or the like, using a transfer member, the transfer member having an adhesive side and a non-adhesive side. One transfer member sufficient to practice applicant's method is presently being sold under the trademark MAGIC COVER®, the registered trademark of Kittrich Corporation, MAGIC COVER® Division, 4500 District Boulevard, Los Angeles, Calif. 90058. Vinyl signage members are supplied to the sign industry by such companies as Spartan International, Inc., 1845 Cedar Holt, Mich. 48842; Vector TM Graphics, 925 Sawmill River Road, Yonkers, N.Y. 10710; and Universal Products, Inc., 21 Industrial 57, Goddard, Kans. 67052. Typically the vinyl signage material is on a backing paper that comes in rolls about 15 inches wide in a variety of color and thicknesses, typically between 2 ml and 4 ml thick.

Applicant's preferred transfer member is the MAGIC COVER® self-adhesive, vinyl, decorative coverings from Kittrich that is available in clear. Heretofore, the Kittrich product has been provided to consumers to affix to the surface of shelves, notebooks, pages, diplomas, posters, cards, books and manuals, newspapers clippings, and the like in order to provide protection and durability to the substrate while allowing viewing of the covered and protected document, shelf or sheet. The nature of the self-adhesive vinyl MAGIC COVER® member has been found to provide the surprising and beneficial advantages heretofore unrealized in existing transfer tape namely, reusability, allowing repeated transfers utilizing the same transfer member. Heretofore, available transfer tape has been used for a single transfer (or, at most, two) of a design from its host paper backing to the substrate and then thrown away. Additional designs or transfers are done with additional sheets of transfer tape. Applicant has discovered a unique usage of the MAGIC COVER® material heretofore unused in the signage industry by applying its highly desirable adhesive characteristics to a unique method of repeatedly reusing the same transfer member for removing vinyl signage designs from protective host paper to a substrate.

Thus, applicant's method begins with the following materials: a properly sized transfer member, such as the MAGIC COVER®; and a sheet of vinyl signage material with the letters, numbers, or other pleasing designs cut out from the roll, and the unwanted vinyl weeded or removed therefrom typically by use of computers through devices and methods known in the trade.

Working in a clean, flat, well-lit area, the worker first applies the adhesive side of the transfer member, after having removed the backing paper (if it comes with backing paper) from the transfer member and laying the backing paper aside for storing the transfer member when not in use or other suitable clean storage surface. Applying the adhesive side of the transfer member to a first vinyl signage design is done with sufficient pressure against the back (non-adhesive) side of the transfer member to adhere the adhesive side of the transfer member to the non-adhesive side of the vinyl signage design. When this is completed, the transfer member is lifted to remove from the paper host material the vinyl signage design. Application of the vinyl signage design to the substrate is the next step. This is done by applying the vinyl signage design in the appropriate location on the substrate and then applying smooth and uniform pressure across the transfer member, urging the adhesive side of the vinyl signage design against the surface of the substrate sufficiently to assure complete and uniform adhesion of the vinyl signage material to the substrate in its proper location. This concluded, removal of the transfer member from the non-adhesive side of the vinyl signage design is proper.

Applicant has discovered a novel method utilizing the heretofore undiscovered (for transfer purposes) material, MAGIC COVER® from Kittrich Corporation, which has the unique ability to retain sufficient adhesion and tackiness to be reused under normal working conditions, typically up to at least 15 times. Applicant has used a single piece 56 times, and it still had sufficient tackiness. Moreover, applicant provides the unique step of allowing the placement of the adhesive side of the transfer member to its original backing papers or other materials, such as vinyl signage design material, while still being capable of being released and reused for transfer purposes. Applicant's method allows the transfer tape to stick to itself when folded onto itself, and to retain its usefulness when pulled apart for reuse.

Applicant has performed the following tests, all utilizing the MAGIC COVER® material:

### Test 1

Utilizing 3 ml Vector vinyl sign material provided by Vector Graphics, Inc. of Yonkers, N.Y. 10710, letters were cut into 4″ height for transfer from the host paper backing material to a coroplast, a corrugated plastic sheet approximately ¼″ thick, in a clean, dry state. Applicant measured and cut a piece of MAGIC COVER® 6″ high and 18″ in length. The paper backing was removed and transfer, according to the steps set forth above, was repeated. The vinyl is precut and the undesired vinyl is removed. A series of 15 words containing 6 letters prespaced on the vinyl backing material was transferred and accurately positioned, one set below the other, on the substrate in approximately 8 minutes. It was observed during this test that, throughout the 15 transfers, there was no discernable loss in the ability of the transfer paper to pick up additional signage material (vinyl or any other like adhesive sign material) after the first signage material was transferred.

### Test 2

The same steps of Test 1 were repeated except that, between each transfer, the transfer member was firmly placed, adhesive side down, on the protective backing paper that the vinyl signage material was removed from. Between each step, the transfer member had to be removed from the backing material; and no discernable curling of the transfer material or loss of tackiness or ability to effect proper adhesion to the vinyl signage material was noticed.

### Test 3

The same steps of Test 1 were repeated except that, prior to the application of the vinyl signage material to the substrate, the substrate material surface to receive the vinyl is sprayed with a mist coating of water, the vinyl letters are applied and squeegeed with sufficient pressure.

Applicant notes that, compared to presently existing transfer tape (which loses its adhesion when it touches the water on the substrate), applicant's unique step allows for repeated use of the same transfer member, even when it has been dampened with water picked up from the substrate.

### Comparison Tests

Applicant's comparison test method consists of the following steps:

A) cutting vinyl letters, all the same size (4″ high and 181″ long) from the same roll of vinyl;

B) preparing the substrate (in this case, clean styrene) onto which letters are to be transferred by wiping with a clean, wet rag and allowing to dry;

C) placing transfer tape (6″×18″) over letters;

D) applying constant pressure to transfer tape through the application of 12 lbs. of weight on a 40 square inch patch to pick up the letters;

E) making 8 passes of the weight at a constant speed over the transfer tape (a pass is the weight going over the tape one time, one way);

F) lifting the transfer tape slowly, with uniform pressure, with letters on tape;

G) placing transfer tape, with letters, onto styrene (no additional pressure applied);

H) using same weight and patch (as in D above) to apply pressure;

I) making 8 passes of the weight at a constant speed over the transfer tape (a pass is the weight going over the tape one time, one way); and

J) pulling transfer tape up.

### Results

1. The above process (A-J) was repeated using one 6″×18″ piece of MAGIC COVER® a total of 15 times with 100% effectiveness each time.

2. The piece of MAGIC COVER® used in “1” was then folded together (in half), opened and used in the same process (A-J above 1 time) with 100% effectiveness.

3. The above process (A-J) was done using one 6″×18″ piece of Vector™ System 3 Premium Application Tape 3 times: the first time with 100% effectiveness, the second time with 70% effectiveness, and the third and subsequent attempts yielding 0% effectiveness. The Vector™ System 3 Premium Application Tape was useless as a transfer tape after the second use. Vector™ System 3 Premium Application Tape is a transfer tape with the same weight, color, and adhesiveness (and other properties) as many other transfer tapes used in the sign industry. There are many brand names of transfer tape with their product interchangeable with other companies' transfer tapes, using the same piece of transfer tape for each transfer.

4. The tests were all done under the same conditions and variables and by the same individual.

5. The word “effectiveness” as used above means applying transfer tape, lifting letters, and reapplying transfer tape with letters on it to the substrate, then lifting the transfer tape off of the letters and leaving 0-100% of the letters on the designated substrate (100% being all the letters, 50% being half the letters, etc.), as desired, without letters sticking to the transfer tape or not releasing from the transfer tape when appropriate.

6. The “letters” in the above process could be any shape, design, numbers, or the like. The purpose was to use identical shapes and sizes in all testing under the same conditions. The term vinyl signage designs is used to denote numbers, letters, or any vinyl designs.

7. A second decorative covering that has been found to be effective as a transfer tape according to applicant's novel method is sold under the registered trademark TYE-TAC®. TYE-TAC® is the registered trademark of Tye-Sil Corporation Ltd. of 5505 Des Grandes Prairies Boulevard, Montreal, Quebec Canada H1R 1B3 (a Canadian corporation).

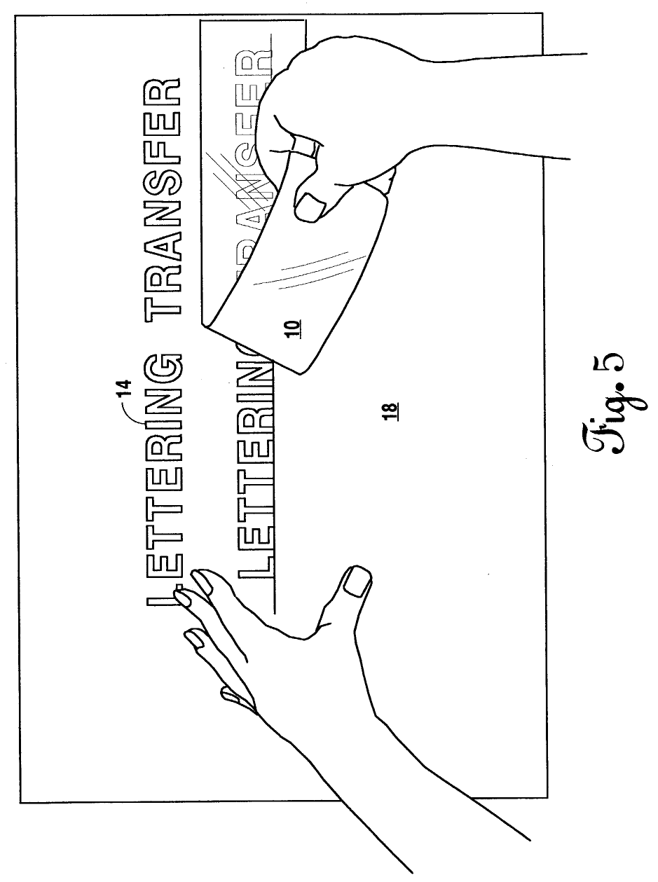

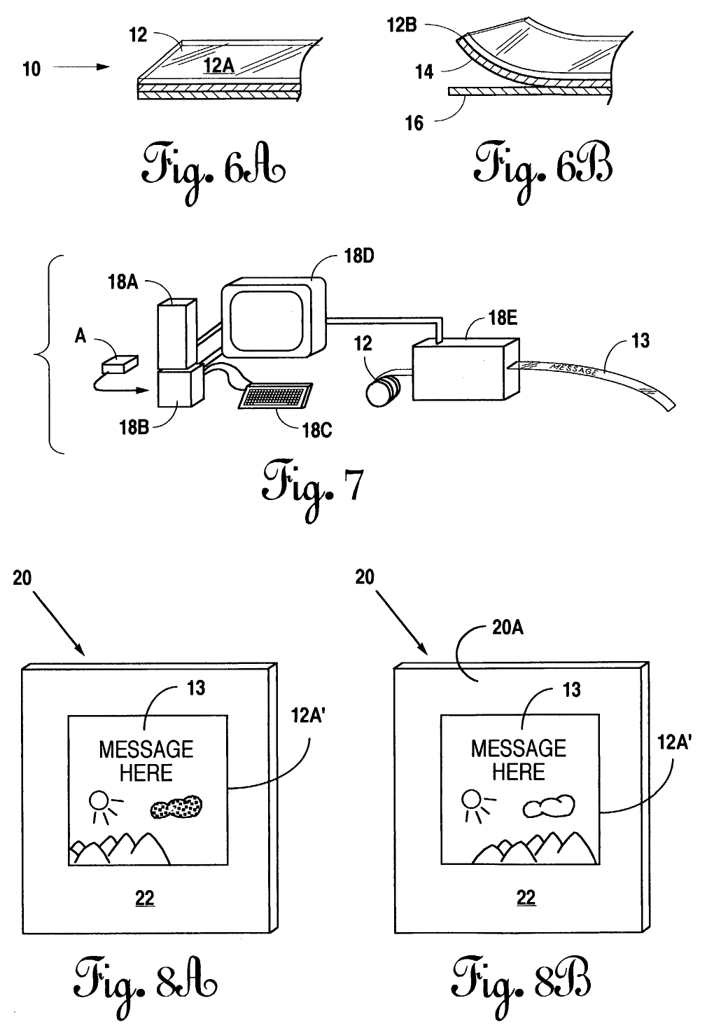

FIGS. 6A and 6B illustrate a composite membrane 10 comprising a pressure sensitive, vinyl sheet 12, having an outer surface 12 A of sheet 12 which may include a custom printed advertising message 13, including words and/or numbers and/or design indicia. The inner surface 12B of flexible vinyl sheet 12 has, on the surface thereof, a layer of adhesive 14. Applicant's composite membrane 10 typically includes siliconized backing paper 16 to protect the adhesive layer until sheet 10 is ready to be applied to a base a set forth in more detail below.

It is noted that composite 10 has adhesive backing 14 which allows the sheet to be applied to a mounting base and then removed and repositioned without the loss of adhesives ability to hold and without the loss of adhesive to the base. Such unique properties in a message-bearing sign allows the user to reposition the sign when necessary, for example, if its original position is improper.

Suppliers of Applicant's composite 10 (without designs thereon) include: Kittrich Corporation, MAGIC COVER® Division, 4500 District Boulevard, Los Angeles, Calif. 90058, and Tye-Sil, of 12225 Boul Industriel, Montreal, Quebec, Canada H1B 5M7 (as Tye-Tac). The unique composite 10 is also available form Exac-Tac, 116 IH 35 South, New Braunfels, Tex. 78130 (as Exac-Tac Substrate).

FIG. 7 illustrates components of a piezo ink jet printer for use with Applicant's method and device as set forth herein. The components and the printer system are available from VUTEk, Inc. 189 Waukewan Street, Meredith, N.H. 02353 (ULTRA VU 5300/3300). The components illustrated an ink jet printing system 18 including computer 18A, such as a personal computer, scanner 18B, keyboard 18C, monitor 18Dm and printer 18E.

The user creates a personalized/customized advertising message for display on the vinyl sheet 12 of Applicant's composite membrane 10. The message A may be scanned into scanner 12B, as necessary, typed on keyboard 18C for manual entry into computer 18A, or created by the user using CAD or similar systems. C.D. ROM's are available which have graphic programs, such as PhotoShop, Corel (Draw), and Page Maker. The software for the message design system is also available from known sources or through VUTEk or Signtech. An advertising message which may include letters and/or numbers and/or designs (pictures) is digitalized and stored in computer 18A which will allow manipulation of the message, if necessary, for display on monitor 18D. Printer 18E receives signals from computer 18A which signals are representative of a pre-selected advertising message A and, through means and devices known in the trade, prints message 13 on Applicant's outer surface 12A flexible sheet 12.

The outer surface of Applicant's flexible vinyl sheet 12 now bears a personalized, custom message 12. Non-stick paper protects the adhesive backing 14. The user now may take the composite and, as illustrated in FIGS. 3A and 3B, position it against a base 20. The base 20 may be coreplast, glass, foam board, a vehicle's outer surface, plexiglass, billboard, window surfaces, banners (such as reinforced vinyl), or the like. Preferred bases include clean, smooth, surfaces such as those set forth in the preceding sentence.

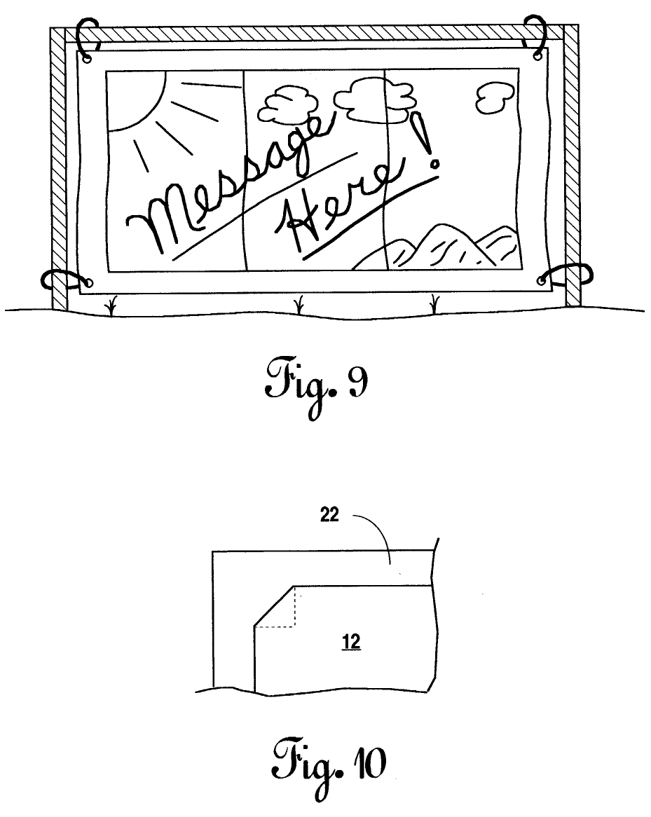

FIGS. 8A and 8B illustrate the unique properties of Applicant's flexible sheet 12. In FIG. 8A, sheet 12, with outer surface 12A′ including indicia thereon, such as an advertising message A, is placed in a first position against an outer surface 22 of suitable base 20.

Before positioning sheet 12, as set forth in FIG. 8A, the protective paper backing 16 is typically removed from the sheet. Inner surface 12B has adhesive 14 thereon with unique properties allowing the base-mounted sheet to be removed, repositioned, and remounted to the same or different base. That is, in FIG. 8A, sheet 12 with inner surface bearing adhesive 14 is pressed against outer surface 22 of base 20 in a first position. Subsequently, the user may reposition flexible sheet 12 with outer surface 12A′ bearing advertising messages 13 thereon. This is done simply by lifting an edge of the flexible sheet and slowing pulling it off the underlying base until the entire sheet is removed therefrom. The user then may position the sheet against the advertising display base in the second position, such as illustrated in FIG. 8B and press the outer surface to urge the adhesive side against the display base. This reattaches the adhesive to outer surface 22 of the base 20 in such a manner that allows the sheet 12 to releasably adhere to outer surface 22 of base 20.

Applicant's sheet also allows one portion of the adhesive backing to contact another portion with subsequent separation retaining the adhesive backing and its effectiveness. This is helpful in a number of ways including tucking a corner of the vinyl back against itself while positioning it, as in FIG. 8C to allow easy lift off for any repositioning. When the tucked in portion of the sheet can be folded out and pressed against the base 22.

Applicant's novel printable, pressure-sensitive, vinyl sheet used as a removable and repositionable substrate for signage is available in clear, white, or other colors. The clear is appropriate for point-of-purchase displays and back-lit displays, also for window graphics with reverse printing. That is, the clear vinyl substrate may have the printing or design reversed through the computer so that when it is mounted on a window it is viewed from the outside of the window as a positive (reversing the reverse print). The white opaque vinyl sheet is appropriate for point-of-purchase displays, vehicle graphics, color presentations, etc.

Use of the large format ink jet printers (the VUTEk and Signtech machines) provides for format printing of up to 54″ in width. This allows for even larger signs, such as billboards, which are typically printed in sections.

Applicant's unique vinyl sheet may be printed on either a large format ink jet printer or a smaller, four color thermal printer such as the ColorCamm, model PNC-5000 by Roland Digital Group of Irvine, Calif. In either case, the signage may be printed in sections of vinyl which are then pieced together to make the complete sign, as set forth in FIG. 9. Applicant's removable and repositionable vinyl sheet is especially useful in such sectioned signage because if the alignment is not close, sections will need to be removed and repositioned. That is, Applicant's unique vinyl sheet, being repositionable, allows for the removal of sections if they are not aligned properly.

Applicant's unique removable and repositionable sheet is mountable to a base, such as a banner, the banner in turn may then be mountable to a large structure, such as a billboard base, as in FIG. 9. In such a fashion, Applicant's unique vinyl sheet may be printed as sections for a large composite vinyl sheet, intending to cover a billboard. By applying the signage to the vinyl sheet, and then multiple sections of message bearing vinyl sheet to the flexible billboard base membrane, the billboard membrane can be reused. In typical prior art, billboard signage designs are transferred directly to the flexible (typical mesh reinforced vinyl) banner membrane, which is then tied tightly to the billboard frame. However, by applying signage to Applicant's sheet, which is pressure-sensitive, removable, and repositionable, and then applying those sheets to the membrane, the billboard base membrane can be reused with different signs after the original sheets are removed.

As set forth in FIG. 2, a computer using one of the aforementioned programs can custom design a sign on the monitor using a program's library or scanned-in photographs, drawings, or images, or a combination thereof. The artist will custom design the sign on the monitor in the proper proportions and run it off for client approval. Following approval, the artist typically downloads the digitally stored design to a CD-Rom or other media, or directly E-Mails it to the printer. The large format ink jet or smaller format heat transfer printer, or other suitable printer, then prints out the signage on Applicant's unique vinyl sheet.

Applicant's vinyl sheet is typically clear, white, or other color, (typically between 2.65 and 3.75 mil virgin mono-polymer calendered vinyl with a thickness range (including water-based adhesive) of 2.95 to 3.05 mil and backed with siliconized paper. During the printing process with the ink jet printer, such as the VUTEk printer, the imaged face may be saturated with a thick coat of high-gloss U.V. protectant clear coating to help resist fading and abrasions.

Among the software used to produce the designs are: Adobe Photoshop; Adobe Illustrator; Adobe After Effects; Adobe Streamline; Adobe Dimensions; Quark Express; Page Maker; FlexiSign; Aldus Freehand; Kai's Power Tools: KPT Bryce; Strata Media Paint; and Photo Library. The software can be run of a Power Mac 8100 or other PC. Fully composed artwork may be accepted in a number of different formats, including: RGB Tiff; CMYK Tiff; and CMYK EPS. The large format machines can accept the artwork on a floppy disk, zip disk, magnetic optical disk, or other form. Further, the machines can scan artwork from photographs (typically 4×5 or 8×10), transparencies, slides, or other media.

Terms such as “left,” “right,” “up,” “down,” “bottom,” “top,” “front,” “back,” “in,” “out,” and the like are applicable to the embodiments shown and described in conjunction with the drawings. These terms are merely for purposes of description and do not necessarily apply to the position or manner in which the invention may be construed for use.

Although the invention has been described in connection with the preferred embodiment, it is not intended to limit the invention's particular form set forth, but on the contrary, it is intended to cover such alternatives, modifications, and equivalences that may be included in the spirit and scope of the invention as defined by the appended claims.

I claim:

1. A base-mountable, customized advertising device, the advertising device including a pressure-sensitive, self-adhesive, flexible, vinyl sheet with an outer surface and an inner surface, the outer surface having a custom designed advertising message printed thereon, and the inner surface having adhesive that is releaseable and repositionable against the base.

2. The device of claim 1 wherein the self-adhesive vinyl sheet leaves no residue upon removal from the base.

3. The device of claim 1 wherein the opaque vinyl sheet is in the range of 3-17 mil.

4. A sign carrying a personalized advertising message, the sign comprising:
a base having a smooth uniform outer surface;
a pressure-sensitive, self-adhesive, flexible, vinyl sheet with an outer surface and an inner surface, the outer surface having a custom designed advertising message printed thereon, and the inner surface having adhesive that is releaseable and repositionable against the base; and
wherein the vinyl sheet is mounted onto the outer surface of the base.

5. A method of making a customized advertising display on a display receptacle, the method comprising the steps of:
a) providing a flexible vinyl sheet having an outer surface and an inner surface, the inner surface bearing an adhesive thereon with a siliconized paper backing covering the adhesive inner surface wherein the properties of the adhesive allow the sheet to be removable and repositionable on the display base without leaving adhesive on the base;
b) selecting an advertising message;
c) printing the message on the outer surface of the sheet;
d) positioning the sheet against the advertising display base;
e) removing the paper from the adhesive side of the sheet; and
f) mounting the adhesive sheet against the side of the base.

6. The method of claim 5 wherein the printing step is performed by a piezo ink jet printer.

7. The method of claim 6 wherein the piezo ink jet printer is manufactured by Signtech®.

8. The method of claim 6 wherein the piezo ink jet printer is manufactured by VUTEk.

9. The providing step 4a) includes a transparent vinyl sheet display base and the printing step of 4c) includes the reversal of the advertising message.

10. The method of claim 5 further including the step of removing the sheet from the base and remounting the sheet to the base.

11. The method of claim 5 wherein the base of step 4a) is a flexible, sheet.
